(19) United States
(12) Patent Application Publication
(10) Pub. No.: US 2014/0240127 A1
(43) Pub. Date: Aug. 28, 2014

(54) ALARM SYSTEM

(71) Applicant: James L. Smith, Henderson, NV (US)

(72) Inventor: James L. Smith, Henderson, NV (US)

(21) Appl. No.: 13/779,012

(22) Filed: Feb. 27, 2013

(51) Int. Cl. G08B 13/02

(52) U.S. Cl. CPC G08B 13/02
USPC 340/545.2

(57) ABSTRACT

An alarm system that abuts against a barrier to help prevent entry. The alarm system includes a support portion, such as a tripod. The support portion forms a footprint for firmly pressing against the barrier at an angle. The footprint includes uneven lengths for the legs, a small distance between the ends of each leg, a brace that securely joins each leg, and support portion mounts that join to the ends of the legs for entrenching firmly into the ground surface. A mounting portion at the other end of the support portion includes a collar shape that is configured to engage a barrier fastener, such as a door knob. The support portion tilts against the barrier to resist a force from the opposite side of the barrier. An alarm portion with a sensor detects a force from the door and emits an alarm as required.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to alarm systems. More particularly, one or more embodiments of the invention relate to alarm systems that help prevent entry.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or an embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that an alarm system gives an audible, visual, or other form of alarm signal about a problem or condition. Alarm systems may also serve as physical barriers to entry.

Typically, burglar alarms, designed to warn of burglaries may include a silent alarm. Often, the police or guards are warned without indication to the burglar, which increases the chances of catching the burglar.

Typically, a tripod is a portable three-legged frame, used as a platform for supporting the weight and maintaining the stability of some other object. A tripod provides stability against downward forces and horizontal forces and movements about horizontal axes.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a detailed perspective view of an exemplary alarm system positioned against a harrier, in accordance with an embodiment of the present invention;

FIG. 2 illustrates a detailed perspective view of an exemplary support portion, in accordance with an embodiment of the present invention;

FIG. 3 illustrates a close up view of an exemplary support portion mount, in accordance with an embodiment of the present invention;

FIG. 4 illustrates a detailed perspective view of an exemplary mounting portion braced against an exemplary barrier fastener, in accordance with an embodiment of the present invention;

FIG. 5 illustrates a side view of an exemplary mounting portion and an exemplary alarm portion, in accordance with an embodiment of the present invention;

FIG. 6 illustrates a detailed perspective view of exemplary brace portions on an exemplary support portion, in accordance with an embodiment of the present invention;

FIG. 7 illustrates a detailed perspective view of an exemplary alarm portion with an exemplary sensor portion actuating an exemplary alarm, in accordance with an embodiment of the present invention;

FIG. 8 illustrates a detailed perspective view of an exemplary alarm portion with an exemplary power source, in accordance with an embodiment of the present invention; and

FIG. 9 illustrates a detailed perspective view of an exemplary alarm system positioned adjacent to an exemplary barrier, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of alarm systems that may be provided by preferred embodiments of the present invention. In one embodiment of the present invention, the alarm system may abut against a barrier to help prevent entry. The barrier may include a door in a closed position. In some embodiments, the alarm system may include at least one support portion for extending form a ground surface to the barrier. The at least one support portion may include a tripod with three legs having uneven lengths. The tripod may function to provide stability against downward and horizontal forces and movements about horizontal axes of the barrier. Those skilled in the art, in light of the present teachings, will recognize that the tripod may tilt at an angle to secure the barrier. The support portion farthest from the barrier may be longer than the two other support portions to facilitate a forward tilt of the complete alarm system towards the barrier. In some embodiment, the front two legs may be longer. When a force is applied to the barrier from an opposite direction, all three support portions may then entrench into a ground surface to enhance resistance against the force. In some embodiments, each support portion may position at an ideal angle efficacious for enhancing a braced support against the barrier. However, each support portion may only be spaced from the other by a minimal space. In this manner, the support portion may provide a sturdy resistance to entry from the barrier while minimizing space white in use or storage. In some embodiments, the at least one support portion may include a straight, rigid frame that does not bend or form an angle.

In one embodiment of the present invention, the at least one support portion may include a brace portion for joining each support portion and providing stability. In embodiments which do not require improved stability, the braces may be omitted, especially if greater portability or collapsibility is desired in the particular application. In some embodiments, the brace portion may include a horizontal support brace. The brace portion may be disposed to position approximately midway in the at least one support portion. In some embodiments, the triangular design may provide maximum support while minimizing the materials required for fabrication. In some embodiments, the at least one support portion may include at least one support portion mount. The at least one support portion mount may include rubber caps that secure to the bottom of the at least one support portion and engage a ground surface. In some embodiments, the at least one support portion mount may be configured to entrench into a variety of ground surface textures and shapes, including, without limitation, tile, marble, carpet, concrete and wood.

In one embodiment of the present invention, an alarm portion may provide an alert upon sensing a force from the barrier. The alarm portion may operatively join with the at least one support portion. In this manner, as the at least one support portion resists the force, the alarm portion may emit an alarm upon sensing the force. In some embodiments, a mounting portion may join with the at least one support portion to join the alarm portion with the barrier. The mounting portion may include a collar. In some embodiments, the alarm system may be joined with a magnet or screws. The collar may include at least one aperture. A rod may pass through any aperture depending on whether the barrier includes a left handed door or a right handed door. The mounting portion may further include a pivot point. The rod may join the mounting portion at the pivot point. In some embodiments, the rod may include a substantially U-shape that may form an angle towards the barrier. In some embodiments, the alarm portion may join with the rod through a bracket. A user may position the rod in a down position to abut the alarm system against the barrier. The user may then position the rod to an up position for setting the sensor flush against the barrier to sense a force applied to the barrier. When the user requires removing the alarm system from the barrier, the rod may be returned to the down position for facilitated removal. However, in other embodiments, a wire may tether the alarm portion to the mounting portion. A sensor may rest against the barrier. In this manner, the sensor may detect a force from the barrier and trigger the alarm portion to emit an alarm. The alarm may include a high decibel alarm. The combination of the at least one support portion and the alarm portion may form a synergy to enhance the overall alarm system. In some embodiments, a power source may provide power to the alarm portion.

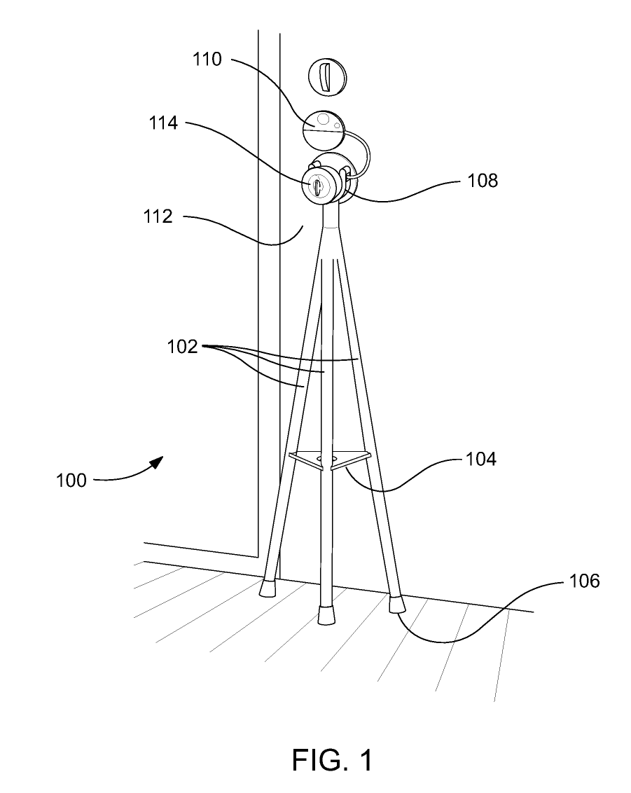

FIG. 1 illustrates a detailed perspective view of an exemplary alarm system positioned against a barrier, in accordance with an embodiment of the present invention. In the present invention, the alarm system 100 may abut against a barrier 112. The barrier may include a door in a closed position. Suitable materials for the alarm system may include, without limitation, galvanized steel, stainless steel, aluminum, iron, and alloys. In some embodiments, the alarm system may include at least one support portion 102 for extending form a ground surface to the barrier. The at least one support portion may include a tripod with three legs having uneven lengths. The tripod may function to provide stability against downward and horizontal forces and movements about horizontal axes of the barrier. However in other embodiments, the at least one support portion may include 1, 2, 4, or more support portions. Those skilled in the art, in light of the present teachings, will recognize that the tripod may tilt at an angle to secure the barrier. The support portion farthest from the barrier may be longer than the two other support portions to facilitate a forward tilt of the complete alarm system towards the barrier. When a force is applied to the barrier from an opposite direction, all three support portions may then entrench into a ground surface to enhance resistance against the force.

In one embodiment of the present invention, each support portion may position at an ideal angle efficacious for enhancing a braced support against the barrier. The ideal angle may include a 70 degree angle. However in other embodiments, the angle may be greater or less depending on the type of barrier and ground surface. Each support portion may only be spaced from the other by a minimal space. In this manner, the support portion may provide a sturdy resistance to entry from the barrier while minimizing space while in use or storage. In some embodiments, the alarm system may include a slim design for portability. In some embodiments, the at least one support portion may include a straight, rigid frame that does not bend or form an angle.

In one embodiment of the present invention, the at least one support portion may include a brace portion 104 for joining each support portion and providing stability. In some embodiments, the brace portion may include a horizontal support brace. The brace portion may be disposed to position approximately midway in the at least one support portion. However in other embodiments, the brace portion may position at various points along a longitudinal axis of the at least one support portion. In some embodiments, the triangular design may provide maximum support while minimizing the materials required for fabrication. In some embodiments, the at least one support portion may include at least one support portion mount 106. The at least one support portion mount may include rubber caps that secure to the bottom of the at least one support portion and engage a ground surface. In some embodiments, the at least one support portion mount may be configured to entrench into a variety of ground surface textures and shapes, including, without limitation, tile, marble, carpet, concrete and wood. The at least one support portion mount may be configured to prevent damage to the ground surface.

In one embodiment of the present invention, an alarm portion 110 may provide an alert upon sensing a force from the barrier. The alarm portion may operatively join with the at least one support portion. In this manner, as the at least one support portion resists the force, the alarm portion may emit an alarm upon sensing the force. The alarm may include, without limitation, a siren, an illumination, and a silent alarm to law enforcement professionals. In some embodiments, a mounting portion 108 may join with the at least one support portion to join the alarm portion with the barrier. The mounting portion may include a collar that is configured to engage a barrier fastener 114. The collar may include at least one aperture. A rod may pass through any aperture depending on whether the barrier includes a left handed door or a right handed door. The mounting portion may further include a pivot point. The rod may join the mounting portion at the pivot point. In some embodiments, the rod may include a substantially U-shape that may form an angle towards the barrier. In some embodiments, the alarm portion may join with the rod through a bracket. A user may position the rod is in a down position to abut the alarm system against the barrier. The user may then position the rod to an up position for setting the sensor flush against the barrier to sense a force applied to the barrier. When the user requires removing the alarm system from the barrier, the rod may be returned to the down position for facilitated removal. However, in other embodiments, a wire may tether the alarm portion to the mounting portion. A sensor may rest against the barrier. In this manner, the sensor may detect a force from the barrier and trigger the alarm portion to emit an alarm. The alarm may include a high decibel alarm. The combination of the at least one support portion and the alarm portion may form a synergy to enhance the overall alarm system. In some embodiments, a power source may provide power to the alarm portion. The power source may include, without limitation, a battery, an external power source; and a solar panel.

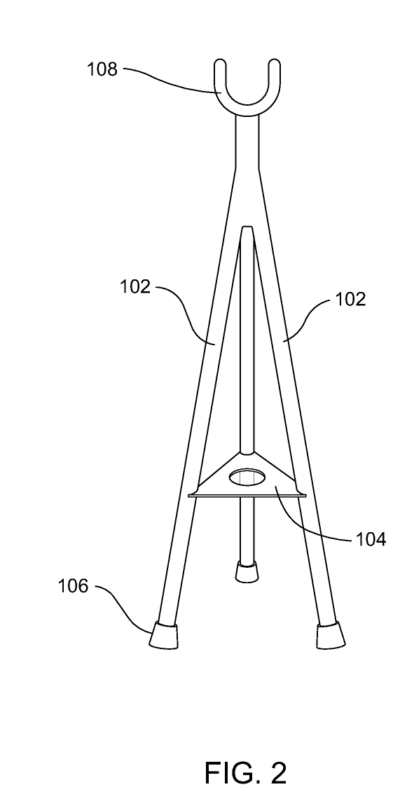

FIG. 2 illustrates a detailed perspective view of an exemplary support portion, in accordance with an embodiment of the present invention. In the present invention, each support portion may position at an ideal angle efficacious for enhancing a braced support against the barrier. The ideal angle may include a 70 degree angle. However in other embodiments, the angle may be greater or less depending on the type of barrier and ground surface. Each support portion may only be spaced from the other by a minimal space. In this manner, the support portion may provide a sturdy resistance to entry from the barrier while minimizing space while in use or storage. Suitable materials for the at least one support portion may include, without limitation, galvanized steel, stainless steel, aluminum, iron, and alloys.

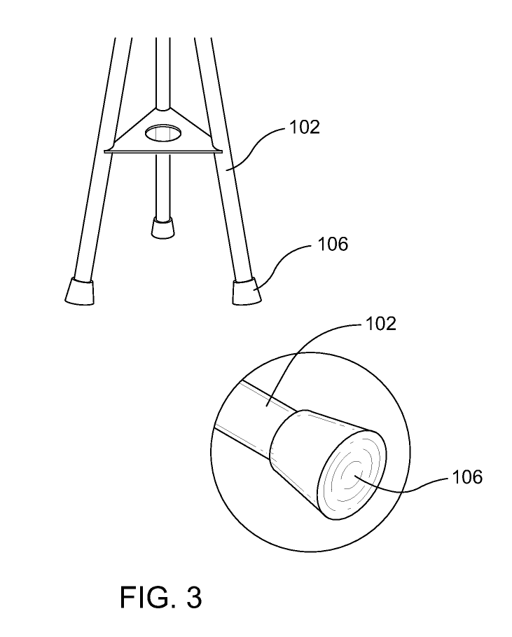

FIG. 3 illustrates a close up view of an exemplary support portion mount, in accordance with an embodiment of the present invention. In the present invention, the at least one support portion mount may include rubber caps that secure to the bottom of the at least one support portion and engage a ground surface. Suitable materials for the support portion mount may include, without limitation, rubber, plastic, polyvinyl chloride, wood, and synthetics. In some embodiments, the at least one support portion mount may be configured to entrench into a variety of ground surface textures and shapes, including, without limitation, tile, marble, carpet, concrete and wood. The at least one support portion mount may be configured to prevent damage to the ground surface.

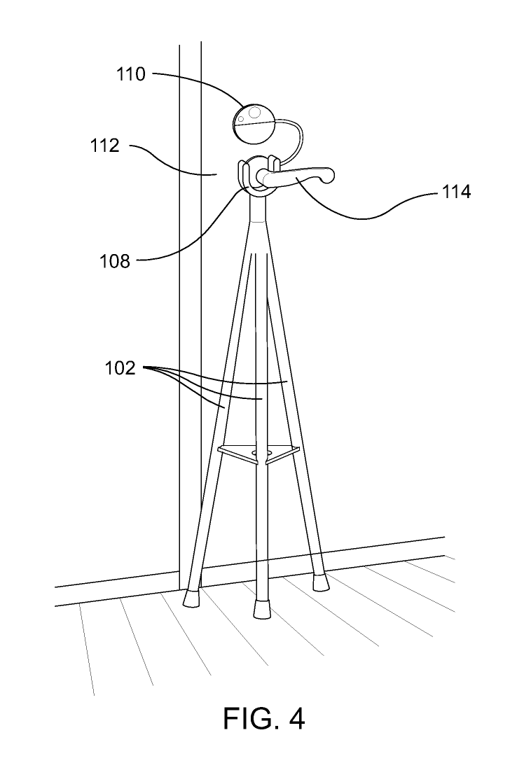

FIG. 4 illustrates a detailed perspective view of an exemplary mounting portion braced against an exemplary barrier fastener, in accordance with an embodiment of the present invention. In the present invention, the barrier fastener may include, without limitation, a door knob, a door lever, and a latch. The collar from the mounting portion may be configured to engage the door knob for joining the alarm portion to the barrier. The mounting portion may further include a rod that joins the mounting portion at a pivot point. In some embodiments, the rod may include a substantially U-shape that may form an angle towards the barrier. The U-shape is efficacious for engaging the door knob. In some embodiments, the alarm portion may join with the rod through a bracket. A user may position the rod is in a down position to abut the alarm system against the barrier. The user may then position the rod to an up position for setting the sensor flush against the barrier to sense a force applied to the barrier. When the user requires removing the alarm system from the barrier, the rod may be returned to the down position for facilitated removal.

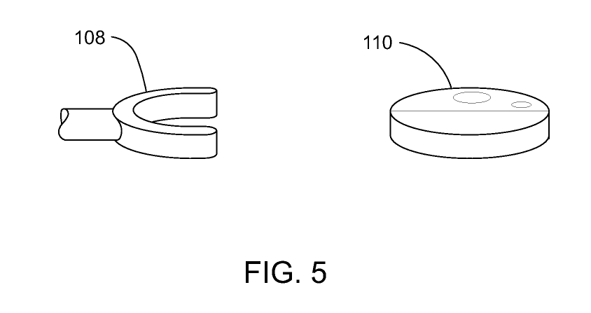

FIG. 5 illustrates a side view of an exemplary mounting portion and an exemplary alarm portion, in accordance with an embodiment of the present invention. In the present invention, a sensor may rest against the barrier. In this manner, the sensor may detect a force from the barrier and trigger the alarm portion to emit an alarm. The alarm may include a high decibel alarm. The combination of the at least one support portion and the alarm portion may form a synergy to enhance the overall alarm system. In some embodiments, a power source may provide power to the alarm portion.

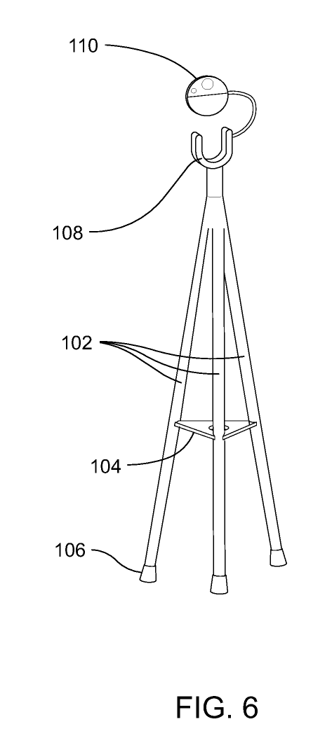

FIG. 6 illustrates a detailed perspective view of exemplary brace portions on an exemplary support portion, in accordance with an embodiment of the present invention. In the present invention, the brace portion may include various shapes and dimensions, including, without limitation, a triangle, a square, a rhombus, and a circle. In some embodiments, the brace portion may position substantially perpendicular to the at least one support portion. However, in other embodiments, the at least one brace portion may form an angle with the at least one support portion. The brace portion may be disposed to position approximately midway in the at least one support portion. In some embodiments, the triangular design may provide maximum support while minimizing the materials required for fabrication.

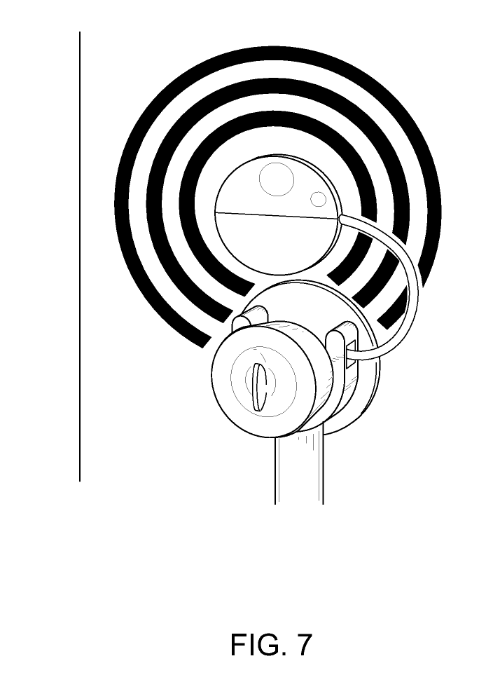

FIG. 7 illustrates a detailed perspective view of an exemplary alarm portion with an exemplary sensor portion actuating an exemplary alarm, in accordance with an embodiment of the present invention. In the present invention, the alarm portion may detect a force from the barrier. The force may include a forward pressure from the opposite side of the barrier. The sensor may detect the force through various means including, without limitation, a motion detector, a sound detector, a vibration detector, and a thermal energy detector. The force may actuate the alarm portion. The alarm may include, without limitation, a high decibel sound, a beeping tone, and a police siren. In one alternative embodiment, the alarm may be silent, yet remotely transmit an alert to law enforcement professionals.

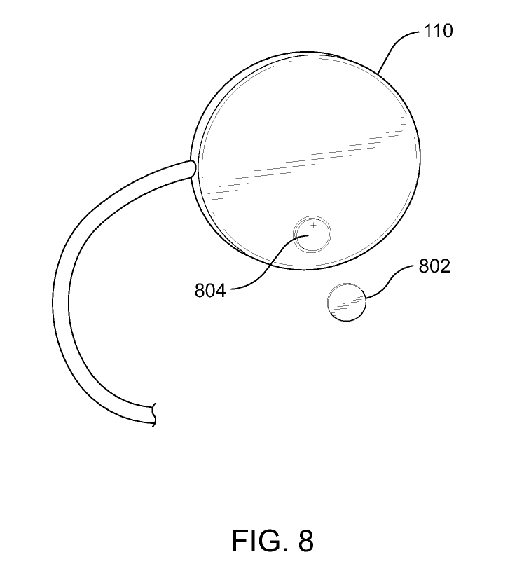

FIG. 8 illustrates a detailed perspective view of an exemplary alarm portion with an exemplary power source, in accordance with an embodiment of the present invention. In the present invention, a sensor 802 may position flush against the barrier to detect a force from the barrier. An alarm may emit from the alarm portion upon detection of the force. A power source 804 may provide power to the alarm portion. The power source may include, without limitation, a battery, an external power source, and a solar panel.

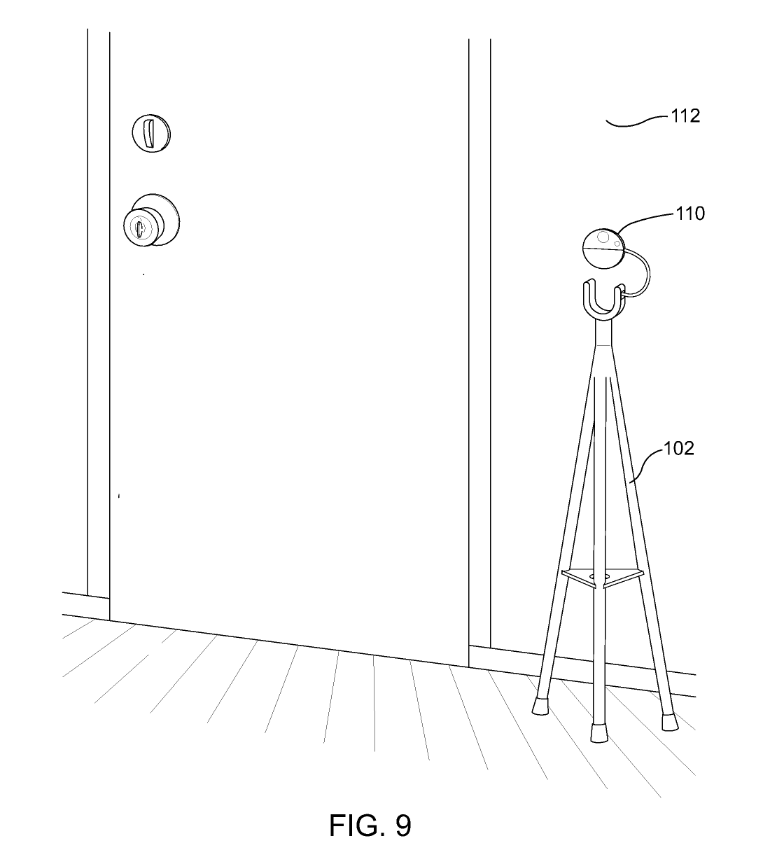

FIG. 9 illustrates a detailed perspective view of an exemplary alarm system positioned adjacent to an exemplary barrier, in accordance with an embodiment of the present invention. In the present invention, the at least one support portion may not abut against the barrier. The alarm portion may provide the security alone. However, in other embodiments, the at least one support portion may provide the security, while the alarm portion remains disengaged.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of alarm systems that abut against a door and emit an alarm upon detecting a force according to the present invention will be apparent to those skilled in the art. Various aspects of the invention have been described above by way of illustration, and the specific embodiments disclosed are not intended to limit the invention to the particular forms disclosed. The particular implementation of the alarm systems that abut against a door and emit an alarm upon detecting a force may vary depending upon the particular context or application. By way of example, and not limitation, the alarm systems that abut against a door and emit an alarm upon detecting a force described in the foregoing were principally directed to tripods that press against doorknobs to prevent entry and trigger alarms implementations; however, similar techniques may instead be applied to vehicle theft prevention systems, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A system comprising:
at least one support, said at least one support portion being configured to at least partially abut against a barrier; and
an alarm portion, said alarm portion being disposed to join with said at least one support portion, said alarm portion further being disposed to engage said barrier, said alarm portion comprising a sensor, said sensor being configured to detect a force from said barrier, said alarm portion being operable to emit an alarm upon detection of said force by said sensor.

2. The system of claim 1, in which said barrier comprises a door.

3. The system of claim 1, in which said at least one support portion comprises a tripod.

4. The system of claim 1, wherein said at least one support portion is operable to extend from a ground surface to said barrier.

5. The system of claim 1, wherein said at least one support portion is configured to have uneven lengths.

6. The system of claim 1, in which said at least one support portion comprises a brace portion.

7. The system of claim 6, wherein said brace portion is configured to join with said at least one support portion.

8. The system of claim 7, wherein said brace portion is configured to position perpendicular to said at least one support portion.

9. The system of claim 1, in which said at least one support portion comprises a mounting portion.

10. The system of claim 9, wherein said mounting portion comprises a substantially U-shape.

11. The system of claim 10, wherein said mounting portion is configured to engage a barrier fastener.

12. The system of claim 11, in which said barrier fastener comprises a door knob.

13. The system of claim 1, in which said at least one support portion comprises at least one support portion mount.

14. The system of claim 13, in which said at least one support portion mount is disposed to engage said ground surface.

15. The system of claim 14, wherein said at least one support portion mount comprises at least one rubber cap.

16. The system of claim 1, wherein said alarm portion is operable to emit a high decibel sound.

17. The system of claim 16, wherein said alarm portion is disposed to position in proximity to said at least one support portion.

18. The system of claim 17, in which said alarm portion comprises a power source.

19. An assembly comprising:
means for abutting a support portion against a barrier;
means for engaging a mounting portion with said barrier;
means for engaging an alarm portion with said barrier;
means for a sensor to detect a force from said barrier; and means for emitting an alarm.

20. A system consisting of
at least one support, said at least one support portion being configured to at least partially abut against a barrier, said barrier comprising a door, said at least one support portion comprising a tripod, said tripod being configured to have uneven lengths, said at least one support portion further comprising a brace portion, said brace portion comprising a horizontal support brace, said at least one support portion further comprising a mounting portion, said mounting portion comprising a substantially U-shape, said mounting portion being configured to engage a barrier fastener, said barrier fastener comprising a door knob, said at least one support portion further comprising at least one support portion mount, said at least one support portion mount disposed to engage a ground surface; and
an alarm portion, said alarm portion being disposed to join with said at least one support portion, said alarm portion further being disposed to engage said barrier, said alarm portion comprising a sensor, said sensor being configured to detect a force from said barrier, said alarm portion being operable to emit a high decibel alarm upon detection of said force by said sensor, said alarm portion further comprising a power source.
